(19) United States
(12) Patent Application Publication
(10) Pub. No.: US 2002/0149148 A1
(43) Pub. Date: Oct. 17, 2002

(54) Multi-layer chopping board

(76) Inventor: Chung-Jung Chen, Feng Yuan City (TW)

Correspondence Address: Alan Kamrath, RIDER BENNETT EGAN & ARUNDEL, LLP, 333 South Seventh Street, Suite 2000, Minneapolis, MN, 55402, US

(21) Appl. No.: 09/833,378

(22) Filed: Apr. 12, 2001

(51) Int. Cl. B23Q 3/00

(52) U.S. Cl. 269/289 R

(57) ABSTRACT

A multi-layer chopping board includes several boards that are stacked with one another. The boards are welded together along outer peripheries thereof to form a connecting wall that connects the boards together. The boards are only connected at their outer peripheries by the connecting wall. Each board includes a groove in a corner thereof. The groove is preferably triangular and defined in an underside of the board. Two sides of the groove are parallel and adjacent to two adjacent sides of the board, respectively. A top wall defining the groove includes an inverted V-shape notch. A topmost line of the inverted V-shape notch defines a separation line that is closest to a top surface of the board.

### BACKGROUND OF THE INVENTION

1. Field of the Invention

The present invention relates to a multi-layer chopping board and more particularly to a chopping board consisting of a plurality of layers of boards.

2. Description of the Related Art

Wooden chopping boards have gradually been replaced by plastic ones, as it becomes more and more difficult to find suitable material for the former. A plastic chopping board can be manufactured easily by choosing suitable plastic material and forming a board by injection molding. Regardless of the material, a chopping board must be discarded once a recess with a considerable depth is defined in a surface thereof as a result of chopping, as the recess may receive dirty material that would contaminate food on the chopping board. A typical chopping board has a thickness of about 1 cm, and it is a waste and results in an additional trash if the chopping board is discarded just because there is a recess having a depth of 1 mm in the surface.

### SUMMARY OF THE INVENTION

It is the primary object of the present invention to provide a multi-layer chopping board consisting of a plurality of layers of boards such that only the uppermost board is discarded if it cannot be used any longer while the remaining boards can still be used.

A multi-layer chopping board in accordance with the present invention comprises a plurality of boards that are stacked with one another. The boards are connected (e.g., by welding) together along outer peripheries thereof to form a connecting wall that connects the boards together.

The boards are only connected at their outer peripheries by the connecting wall. Each board includes a groove in a corner thereof. The groove is preferably triangular and defined in an underside of the board. Two sides of the groove are parallel and adjacent to two adjacent sides of the board, respectively. A top wall defining the groove includes an inverted V-shape notch. A topmost line of the inverted V-shape notch defines a separation line that is closest to a top surface of the board.

When a recess of a considerable depth is defined in the top surface of the uppermost board, the user may cut the corner of the uppermost board along the separation line defined in the inverted V-shape notch. After cutting the corner from the uppermost board, a gap between the uppermost board and the board right below the uppermost board is exposed. Then, the user may extend a thin blade into the gap and cut a portion of the thin connecting wall between the two boards. After cutting, the uppermost board is separated from the remaining boards and discarded. The remaining boards can still be used to the last one.

Other objects, advantages, and novel features of the invention will become more apparent from the following detailed description when taken in conjunction with the accompanying drawings.

### BRIEF DESCRIPTION OF THE DRAWINGS

FIG. 1 is an exploded bottom perspective view of a multi-layer chopping board in accordance with the present invention.

FIG. 2 is a bottom view of the multi-layer chopping board in accordance with the present invention.

FIG. 3 is a top view of a corner of the multi-layer chopping board in accordance with the present invention.

FIG. 4 is a sectional view of the multi-layer chopping board in accordance with the present invention.

### DETAILED DESCRIPTION OF THE PREFERRED EMBODIMENT

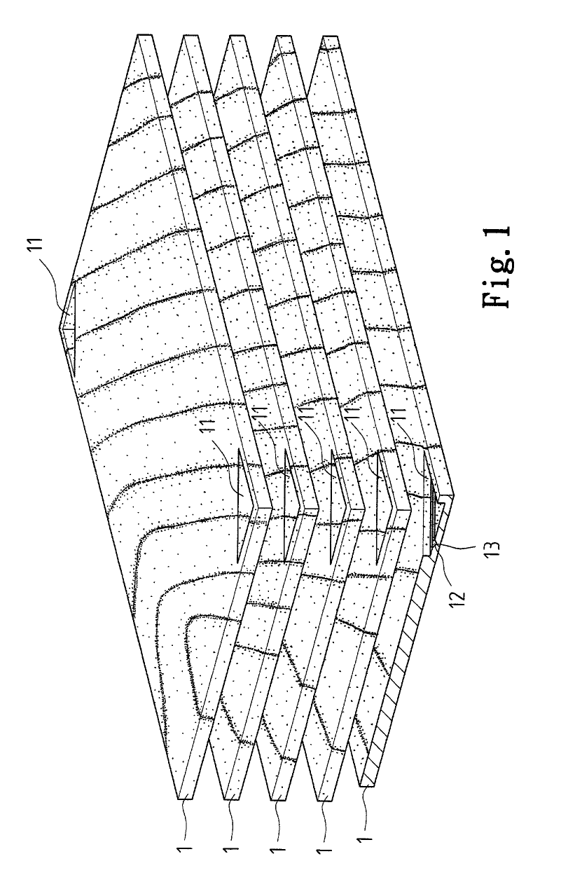

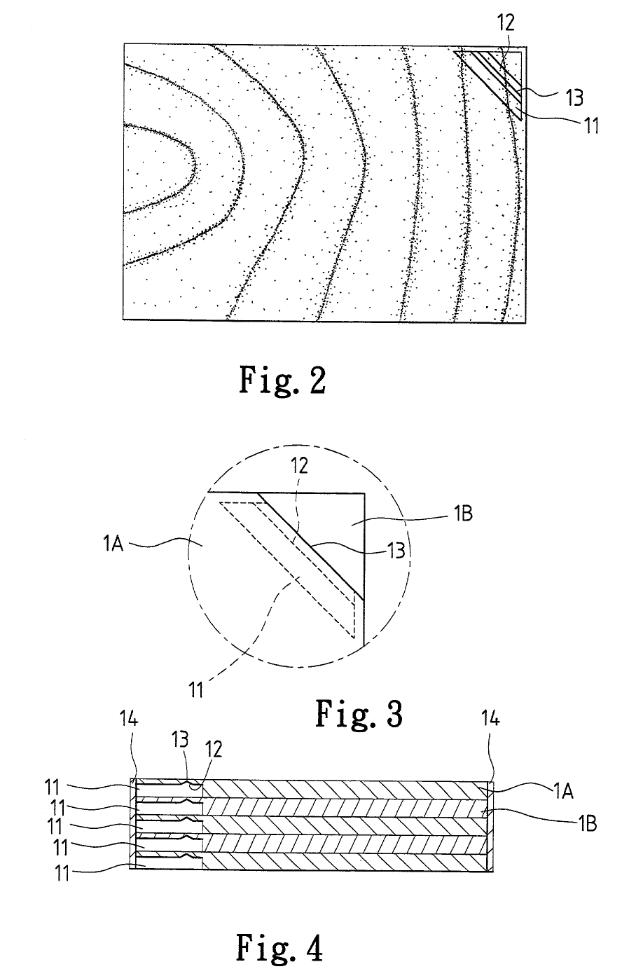

Referring to FIGS. 1 through 4 and initially to FIGS. 1, 2, and 4, a multi-layer chopping board in accordance with the present invention generally includes a plurality of boards 1 that are stacked with one another, wherein the boards 1 are welded (by e.g., ultrasonic or heat welding) together along outer peripheries thereof to form a substantially rectangular connecting wall 14 that connects the boards 1 together. The connecting wall 14 may be as thin as possible while bonding all of the boards 1 together. It is noted that the boards 1 are only connected at their outer peripheries by the connecting wall 14. Namely, the bottom surface of an upper board 1 is not engaged with the top surface of a lower board 1.

In this embodiment, there are five boards 1 each having a thickness of about 2 mm to thereby provide a chopping board having an overall thickness of about 1 cm. In a case that a recess of a considerable depth is defined in the uppermost board 1, the uppermost board 1 is separated from the rest of the boards and then discarded. The remaining boards can still act as a chopping board. Thus, the longevity of the chopping board is lengthened by several times when compared with a conventional chopping board.

For easy separation, at least one corner of each board 1 includes a substantially triangular groove 11 in an underside thereof. Two sides of the triangular groove 11 are parallel to and adjacent to two adjacent sides of the board 1, respectively. The corners of the boards 1 having the grooves 11 are aligned with each other, best shown in FIG. 4. A top wall defining a portion of the groove 11 has a substantially inverted V-shape notch 12. A topmost line of the inverted V-shape notch 12 defines a separation line 13 that is closest to a top surface of the board 1. When a recess of a considerable depth is defined in the top surface of the uppermost board 1, the user may cut the corner of the uppermost board 1A (FIG. 3) along the separation line 13 defined in the inverted V-shape notch 12. The user may clearly see the separation line 13 from top, as the boards are translucent and the separation line 13 of the uppermost board 1A is close to the top surface of the uppermost board 1A. After cutting the corner from the uppermost board 1A, a gap between the uppermost board 1A and the board 1B right below the uppermost board 1A is exposed. Then, the user may extend a thin blade into the gap and cut a portion of the thin connecting wall 14 between the two boards 1A and 1B. After cutting, the uppermost board 1A is separated from the remaining boards and discarded. The remaining boards 1B and 1 can still be used to the last one. It is noted that the uppermost board can be separated from the other boards by any possible means.

According to the above description, it is appreciated that longevity of the chopping board is lengthened by several times, as every board 1 can be used. The problem of waste and trash is mitigated.

Although the invention has been explained in relation to its preferred embodiment, it is to be understood that many other possible modifications and variations can be made without departing from the scope of the invention as hereinafter claimed.

What is claimed is:

1. A multi-layer chopping board comprising a plurality of boards that are stacked with one another, the boards being connected together along outer peripheries thereof.

2. The multi-layer chopping board as claimed in claim 1, wherein the boards are welded together along the outer peripheries thereof to form a connecting wall that connects the boards together.

3. The multi-layer chopping board as claimed in claim 1, wherein the boards are only connected at their outer peripheries by the connecting wall.

4. The multi-layer chopping board as claimed in claim 1, wherein each said board includes a groove in a corner thereof.

5. The multi-layer chopping board as claimed in claim 4, wherein the groove is defined in an underside of the board.

6. The multi-layer chopping board as claimed in claim 5, wherein the groove is triangular.

7. The multi-layer chopping board as claimed in claim 6, wherein two sides of the groove are parallel and adjacent to two adjacent sides of the board, respectively.

8. The multi-layer chopping board as claimed in claim 7, wherein a top wall defining the groove includes an inverted V-shape notch, a topmost line of the inverted V-shape notch defining a separation line that is closest to a top surface of the board.
